(19) United States
(12) Patent Application Publication
(10) Pub. No.: US 2022/0355394 A1
(43) Pub. Date: Nov. 10, 2022

(54) TOOLS AND METHODS FOR FORMING A HOLE WITH COUNTERSINK IN STACKED COMPONENTS

(71) Applicant: The Boeing Company, Chicago, IL (US)

(72) Inventors: John Philip Scheibel, Maryville, IL (US); James Leonard Scherer, St. Peters, MO (US); Michael Anthony Ward, University City, MO (US)

(21) Appl. No.: 17/660,276

(22) Filed: Apr. 22, 2022

Related U.S. Application Data
(60) Provisional application No. 63/185,828, filed on May 7, 2021.

(51) Int. Cl. B23B 51/10

(52) U.S. Cl. CPC B23B 51/107

(57) ABSTRACT

A tool and method are provided for forming a plurality of aligned full-sized holes from a plurality of preformed holes that are near full-size in respective stacked components of a stack-up overlapped in relation to each other. The tool includes a hole cutter having a hole cutter outer diameter, a countersink cutter with a hole widening section, and a pilot member having a pilot diameter smaller than the hole cutter outer diameter and substantially equal to the preformed hole diameter minus the maximum allowable offset distance, so that the hole cutter outer diameter is greater than or equal to the preformed hole diameter plus the maximum allowable offset distance. Other tools and methods for forming countersinks are also provided.

### CROSS REFERENCE TO RELATED APPLICATIONS

This application claims priority to U.S. Provisional Patent Application Ser. No. 63/185,828, filed May 7, 2021, the entirety of which is hereby incorporated herein by reference for all purposes.

### FIELD

This disclosure relates generally to tools and methods for forming a hole with a countersink from a plurality of preformed holes in stacked components, such as body panels of aircraft, spacecraft, or other vehicles.

### BACKGROUND

Stacked components in many manufactured articles, such as body panels in aircraft, spacecraft, or other vehicles, are affixed to each other using fasteners that extend through holes. Each of the stacked components can include, for example, a pattern of multiple preformed holes that matches a pattern of preformed holes on another one of the stacked components. When the components are stacked and positioned to be assembled, pairs of the preformed holes on each component are generally aligned. However, slight differences in the alignment among the pairs of preformed holes can result due to manufacturing variances, dimensional changes in the components due to heat and/or humidity, changes in shape of the components due to transport and handling, positional variances during assembly, etc. Some applications utilize fasteners that are flush or recessed when installed. For these applications, a countersink can be provided. However, when the holes are misaligned as described above, the countersink can be difficult to properly align.

### SUMMARY

According to one aspect, a tool is provided for creating a full-sized hole and countersink from a plurality of preformed holes that are near full-size and that are in respective stacked components of a stack-up overlapped in fixed positional relation to each other. A through-hole is formed through an overlapping region of the preformed holes. Each preformed hole has a preformed hole diameter and an offset distance less or equal to a maximum allowable offset distance. The tool comprises a hole cutter having a hole cutter outer diameter; a countersink cutter with a hole widening section adjacent the hole cutter; and a pilot member formed adjacent the hole cutter. The hole widening section widens from the hole cutter outer diameter to a countersink cutter outer diameter larger than the hole cutter outer diameter. The pilot member is coaxial to the hole cutter and the countersink cutter. The pilot member has a pilot diameter smaller than the hole cutter outer diameter and substantially equal to the preformed hole diameter minus the maximum allowable offset distance. The pilot diameter is sized to pass through the through-hole. The hole cutter outer diameter is greater than or equal to the preformed hole diameter plus the maximum allowable offset distance.

According to another aspect, a tool is provided for creating a countersink hole from a first preformed hole and a second preformed hole in respective stacked components. The first preformed hole and the second preformed hole have a preformed hole diameter and are offset by an offset distance less than or equal to a maximum allowable offset distance so as to be at least partially overlapped in fixed positional relation to each other. A through-hole is formed through an overlapping region of the preformed holes. The tool comprises a pilot member having a pilot diameter that is equal to the preformed hole diameter minus the maximum allowable offset distance; and a countersink cutter with a hole widening section widening from the pilot diameter to a countersink cutter outer diameter larger than the pilot diameter. The countersink cutter is formed coaxial with the pilot member. The pilot member is configured to contact at least one of a first side of the first preformed hole or an opposite side of the second preformed hole to thereby position a central axis of the tool centered between an axis of the first preformed hole and an axis of the second preformed hole, when the pilot member is inserted in the through-hole.

The features, functions, and advantages that have been discussed can be achieved independently in various embodiments or can be combined in yet other embodiments further details of which can be seen with reference to the following description and drawings.

### BRIEF DESCRIPTION OF THE DRAWINGS

FIG. 1 is a schematic illustration of a tool for creating a full-sized hole from a plurality of preformed holes that are near full-size according to a first embodiment of the present disclosure.

FIG. 2 is a schematic illustration of a first component and a second component positioned to be joined together by fasteners according to an example of the present disclosure.

FIG. 3 is a schematic illustration of a preformed hole of a first component and a preformed hole of a second component overlapping each other when the first and second components are stacked together in a stack-up according to an example of the present disclosure.

FIG. 4 is a schematic diagram illustrating three stages of a process for use in joining a first component and a second component together according to the first embodiment of the present disclosure.

FIGS. 5A and 5B are schematic diagrams illustrating the relative sizes and positions of the first preformed hole, the second preformed hole, and the through-hole relative to the pilot diameter, hole cutter outer diameter, countersink cutter outer diameter, and the hole cutter intermediate diameter of the tool according to the first embodiment of the present disclosure.

FIG. 6 is a schematic illustration of a tool for creating a countersink hole from a first preformed hole and a second preformed hole in respective stacked components according to a second embodiment of the present disclosure.

FIG. 7 is a schematic diagram illustrating three stages of a process for use in joining a first component and a second component together according to the second embodiment of the present disclosure.

FIGS. 8A and 8B are schematic diagrams illustrating the relative sizes and positions of the first preformed hole, the second preformed hole, and the through-hole relative to the pilot diameter and the countersink cutter outer diameter of the tool according to the second embodiment of the present disclosure.

FIG. 9 is a flowchart of a method for creating a full-sized hole with a countersink from a plurality of preformed holes that are near full-size according the first embodiment of the present disclosure.

FIG. 10 is a flowchart of a method for creating a countersink hole from a first preformed hole and a second preformed hole in respective stacked components according to the second embodiment of the present disclosure.

FIG. 11 is a schematic illustration of an exemplary aircraft in accordance with the embodiments and examples according to the subject disclosure.

### DETAILED DESCRIPTION

With reference to the difficulty of forming countersinks when preformed holes in a stack-up of components are misaligned as described above, it will be appreciated that conventional techniques for producing countersinks center the countersink on a topmost hole. If such techniques are used with a stack of components including misaligned preformed holes as described above, a countersink formed to be centered on a preformed hole in a topmost component of the stack will be misaligned relative to preformed holes in lower components in the stack. A fastener installed into such a misaligned countersink can produce an inferior connection that is not as strong and/or that has a shorter useful lifecycle.

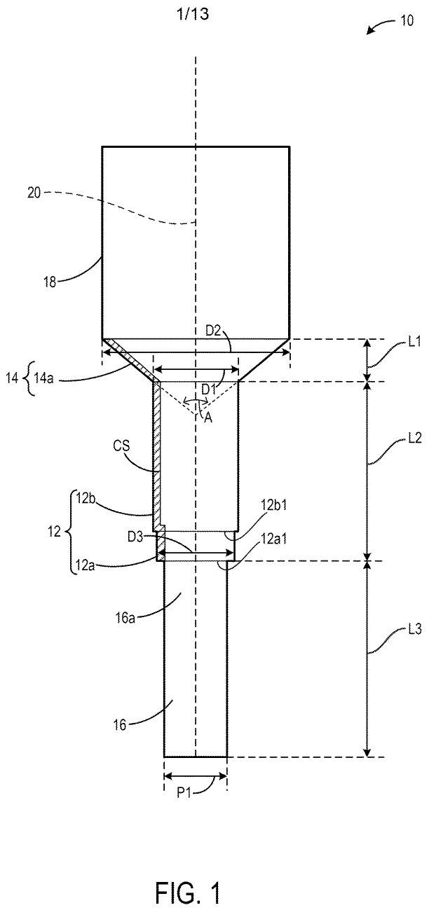

To address this issue, as shown in FIG. 1, a tool 10 is provided according to a first embodiment of the disclosure, for creating a full-sized hole with a countersink from a plurality of preformed holes that are near full-size. As used herein, a near full-sized hole, or a hole that is near full-size, is a hole within a part or component that is an undersized hole relative to a designated full size, or finished, hole for the insertion of a final fastener to connect the part or component to one or more additional parts or components. In other words, the diameter of a near full-sized hole is smaller than the designated diameter of the full-sized hole to accept an intended final fastener. The designated diameter of the full-sized hole can be equal to or slightly larger than the diameter of the final fastener to be inserted into the full-sized hole. Alternatively, the designated diameter of the full-sized hole can be slightly smaller than the diameter of the final fastener to be inserted into the full-sized hole. Such an oversized final fastener would cause an interference fit when inserted. Typically, the full size, or finished hole, will be designated within an engineering specification detailing the assembly of the two or more components.

Continuing with FIG. 1, the tool 10 comprises a hole cutter 12, a countersink cutter 14, and a pilot member 16. The pilot member 16 is formed adjacent the hole cutter 12. The pilot member 16 is coaxial to the hole cutter 12 and the countersink cutter 14 along a centerline 20.

The hole cutter 12 has a hole cutter outer diameter D1. The hole cutter 12 comprises a first stepped section 12a and a second stepped section 12b, the second stepped section 12b having the hole cutter outer diameter D1, and the first stepped section 12a has a hole cutter intermediate diameter D3 smaller than the hole cutter outer diameter D1. A first preformed hole cutting surface 12a1 of the first stepped section 12a is configured to bore a hole at the hole cutter intermediate diameter D3. A second preformed hole cutting surface 12a1 of the second stepped section 12b is configured to bore a hole at the hole cutter outer diameter D1. The hole cutter 12 has a hole cutter length L2 measured from the first cutting surface 12a1 of the first stepped section 12a to the countersink cutter 14.

The countersink cutter 14 comprises a hole widening section 14a adjacent a body 18 of the tool 10. The hole widening section 14a is also adjacent the hole cutter 12, widening from the hole cutter outer diameter D1 to a countersink cutter outer diameter D2 larger than the hole cutter outer diameter D1. The hole widening section 14a has a hole widening section length L1 measured between the hole cutter 12 and the body 18 of the tool 10. The hole widening section 14a can be partially conical (i.e., frustoconical) in profile, with cutting surfaces formed at a countersink angle A centered on centerline 20. The countersink angle A can be in a range from 60-120 degrees, in one example. As non-limiting examples, specific countersink angle values of 60, 82, 90, 100, 110 and 120 degrees are possible. Alternatively, the hole widening section 14a can have a curved profile or stepped profile. Thus, the hole widening section can form a recess that accommodates fastener heads that are tapered, curved, or cylindrical.

It will be appreciated that surfaces 14a, 12a, and 12b form an aggregated cutting surface CS of the tool 10. Cutting surface CS is illustrated schematically, and the actual form of the cutting surface can vary. For example, the cutting surface CS can be fluted with a suitable number of flutes such as one, two, three of more flutes. Each flute terminates in a cutting surface at a distal end. The body 18 can have dimensions suitable for insertion into a chuck, and thus it will be appreciated that body 18 can include a change in width (via a step or taper) from D2 to a width that is insertable into a desired chuck. The circumferential surface of the body 18 is smooth and does not include a cutting surface.

The pilot member 16 has a pilot diameter P1 and includes a cylindrical or generally cylindrical shaft 16a. The shaft 16a typically includes a smooth external surface and is devoid of a cutting surface, but can be fluted in some examples. A pilot length L3 of the pilot member 16 is measured along the centerline 20 from the first stepped section 12a of the hole cutter 12. The hole cutter intermediate diameter D3 of the first stepped section 12a and the hole cutter outer diameter D1 of the second stepped section 12b are larger than the pilot diameter P1.

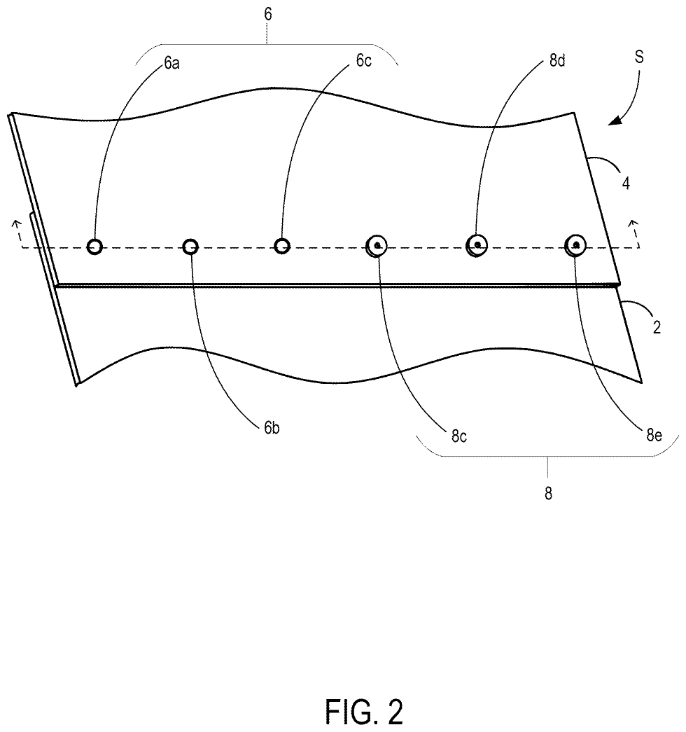

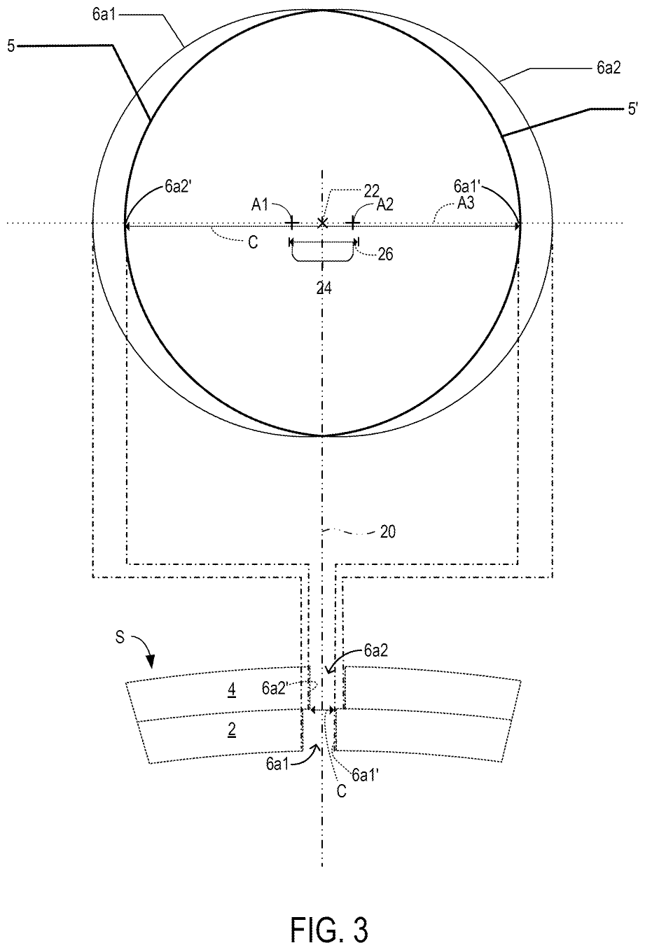

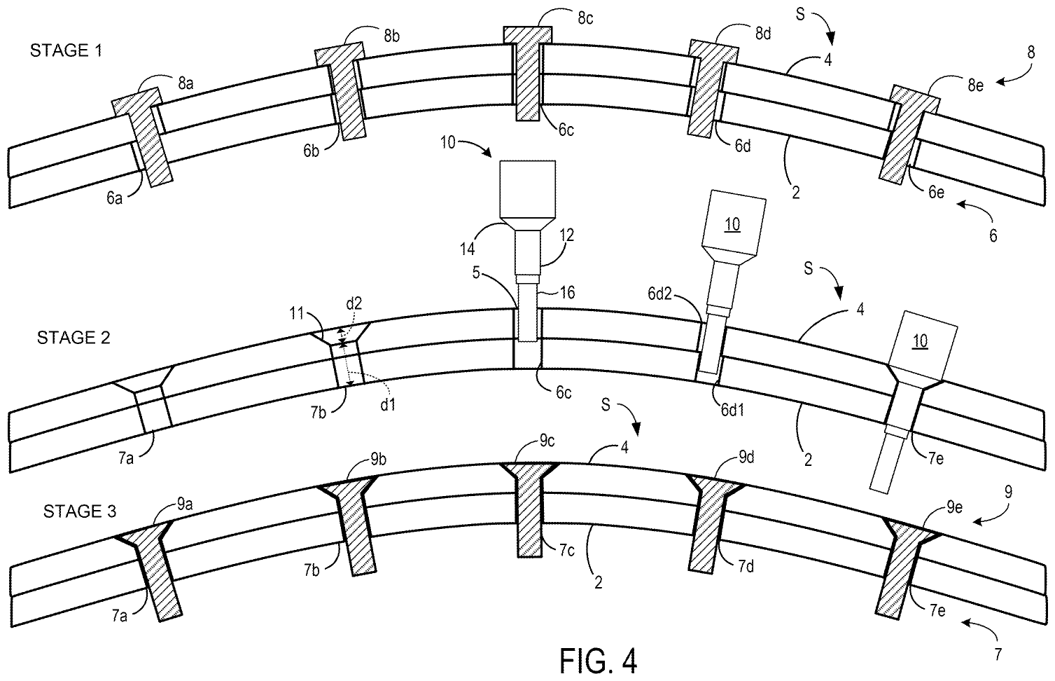

Referring to FIG. 2, a schematic diagram is shown of two components, first component 2 and second component 4, being joined together. The first component 2 and the second component 4 are in overlying or stacked relationship to one another. Near full-sized holes 6 have been formed in each of first and second components 2 and 4. In this view, individual near full-sized holes 6a, 6b, 6c are illustrated. Near full size holes 6 are undersized holes relative full-sized holes 7 (see FIG. 4). In attaining aligned full-sized holes 7, temporary fasteners 8, of which individual temporary fasteners 8c, 8d, and 8e are illustrated in this view, can be inserted through the near full-sized aligned holes 7 to align the first and second components 2 and 4 of the stack up S. The temporary fasteners 8 are sized to have a shaft diameter that is equal to the preformed hole diameter of the near full-sized holes 6 minus a maximum allowable offset distance (see 26 in FIG. 3) between the near full-sized holes 6. Therefore, successful insertion of the temporary fasteners 8 in all of the pairs of near full-sized holes 6 ensures that all hole pairs are properly aligned for insertion of tool 10, as discussed below in particular in relation to FIG. 4.

Referring to FIG. 3, the plurality of preformed holes includes a first preformed hole 6a1 having a first central axis A1 and a second preformed hole 6a2 having a second central axis A2. First preformed hole 6a1 is defined by and extends through the first component 2 and the second preformed hole 6a2 is defined by and extends through the second component 4. The first preformed hole 6a1 and the second preformed hole 6a2 are separately cut through (or otherwise formed in) the first component 2 and the second component 4, respectively, when each of the first component 2 and the second component 4 are fabricated, prior to being layered in the stack-up S.

At least a portion of a boundary 6a1′ of the first preformed hole 6a1 and at least a portion of a boundary 6a2′ of the second preformed hole 6a2 define a clearance gap C and a non-cylindrical perimeter 5′ of the through-hole 5 along major axis A3. An axis 22 of the through-hole 5 is centered between the first central axis A1 of the first preformed hole 6a1 and the second central axis A2 of the second preformed hole 6a2. The portions 6a1′, 6a2′ are sides of the preformed holes defining the clearance gap C and are positioned along the major axis A3, horizontally opposite and vertically adjacent each other in the cross sectional view of FIG. 3. A maximum allowable offset distance 26, which is a maximum amount of misalignment of the initial pair of holes that would allow a circumference of a pilot member having the pilot diameter to pass through the boundaries 6a1′, 6a2′ of the initial pair of holes, is defined by a predefined maximum distance between a center (first central axis A1) of the first preformed hole 6a1 and the center (second central axis A2) second preformed hole 6a2.

The first central axis A1 and the second central axis A2 are aligned along a major axis A3 of the non-cylindrical through-hole 5. In this example, the actual offset distance 24 is substantially equal to the maximum allowable offset distance 26. However, it will be appreciated that the actual offset distances of the multiple hole pairs can vary. The actual offset distance 24 of each hole pair can be caused at least in part by a relative lateral shift in the components at a location of the hole pair due to a variety of factors, including curvature of the components. It will be appreciated that each preformed hole has a preformed hole diameter and an offset distance less or equal to a maximum allowable offset distance 26.

Equidistant between the first central axis A1 and the second central axis A2 along the major axis A3 is the centerline 20, which can be the axis of the first preformed hole 6a1 and the second preformed hole 6a2. A hole position tolerance is applied to the first preformed hole 6a1 and the second preformed hole 6a2.

In this example, the first preformed hole 6a1 and the second preformed hole 6a2 each have the same diameter, which is smaller than a diameter called for in the engineering specifications for a finished aligned full-sized holes used for securement of the first component 2 and the second component 4. To attain engineering specifications for finished full-sized aligned holes, the diameters of the first preformed hole 6a1 and the second preformed hole 6a2 are increased in dimension and the resulting holes are in alignment with one another to receive full-sized final fasteners 9 for optimal securement. It will be appreciated that the maximum allowable offset distance 26 can alternatively be referred to as a ‘tolerance of misalignment’.

Referring to FIG. 4, a schematic diagram is provided, illustrating three stages of joining a first component 2 and a second component 4 together according to the first embodiment of the present disclosure. FIG. 4 illustrates a cross section of stack-up S, taken from a cutting plane similar to one shown in dashed lines in FIG. 2. In FIG. 4, a plurality of preformed holes 6 are illustrated at 6a-6e in respective stacked components (i.e., first component 2 and second component 4) of a stack-up S overlapped in fixed positional relation to each other. A through-hole 5 is formed through an overlapping region of each of the preformed holes 6. The stacked components 2 and 4 can be layers in a stack-up that can be flat or have a curvature. In the illustrated configuration, the stacked components 2 and 4 are shown to be curved according to a curvature. In stage 1, temporary fasteners 8, individually labeled 8a-8e, are inserted through the through-holes 5 of the preformed holes 6a-6e to temporarily secure the first component 2 and the second component 4 together. In stage 2, a tool 10 is inserted into the preformed holes 6a-6e to form the finished full-sized aligned holes 7, which are individually illustrated as 7a-7e.

In this example, the tool 10 is inserted into the through-hole 5 a first predetermined distance d1 to fit the pilot member 16 in the through-hole 5. The preformed holes 6a-6e are subsequently bored out with the hole cutter 12 of the tool 10 by advancing the tool 10 at least a first predetermined distance d1 under rotation into the through-hole 5 to thereby produce each full-sized hole 7. Each full-sized hole 7 circumscribes or encompasses the pair of preformed holes 6. For example, full sized hole 7d is formed to encompass preformed holes 6d1, 6d2. Then, a countersink hole 11 is formed in each full-sized hole 7 by further advancing the tool 10 at least a second predetermined distance d2 under rotation into the through-hole 5 to cause the countersink cutter 14 to cut the countersink hole 11 in the full-sized hole 7. In stage 3, final fasteners 9, labeled individually as 9a-9e, are installed into the finished full-sized aligned holes 7a-7e with countersink holes 11 to join the first component 2 and the second component 4 together.

Accordingly, since the pilot member 16 extends through all of the stacked components (i.e., through 2 and 4 in the example shown) in the stack-up S, the countersink hole 11 that is produced by the countersink cutter 14 is centered not only on the portion of the full-sized hole 7c in the second component 4, but also on the portion of the full-sized hole 7c in the first component 2. This ensures that the sides of the final fastener 9 are parallel to and engage with the sides of the through-hole as designed, without any unintended stress concentrations due to misalignment or non-parallel orientation. Where threaded fasteners are used, this ensures the threads of the fastener engage with the threads of the hole as designed, avoiding damage to the threads or unintended stress concentrations on the threads. Further, the heads of the final fasteners 9a-9e are snugly seated circumferentially inside the countersink holes 11, thereby further promoting a secure connection. In this manner, proper alignment of the countersink promotes the strength and longevity of the connection.

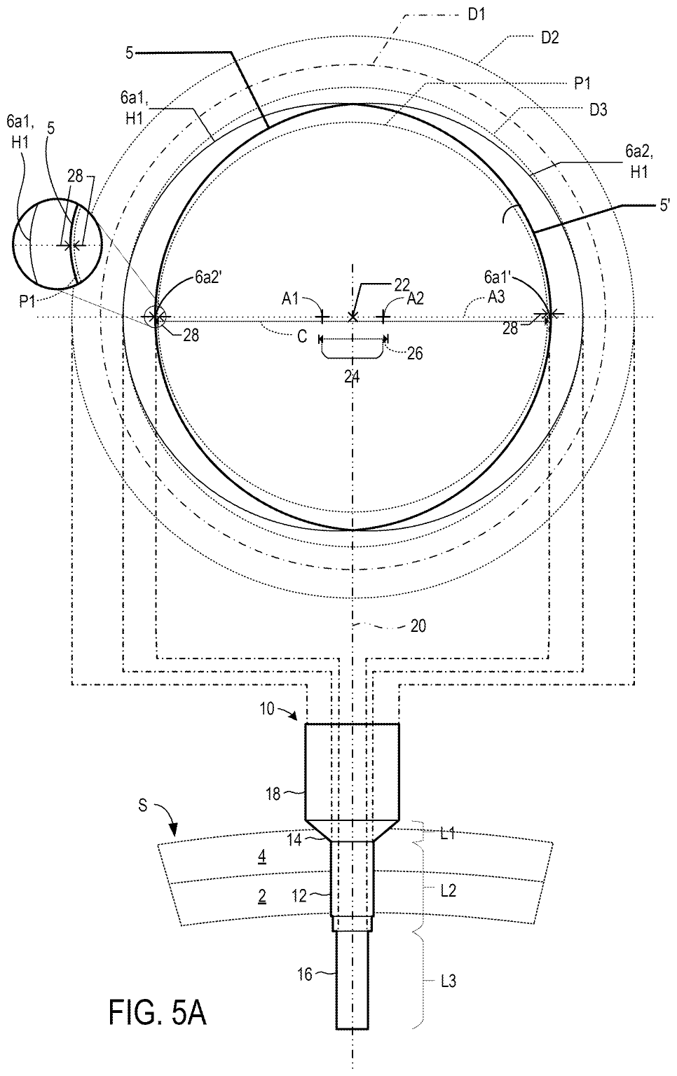

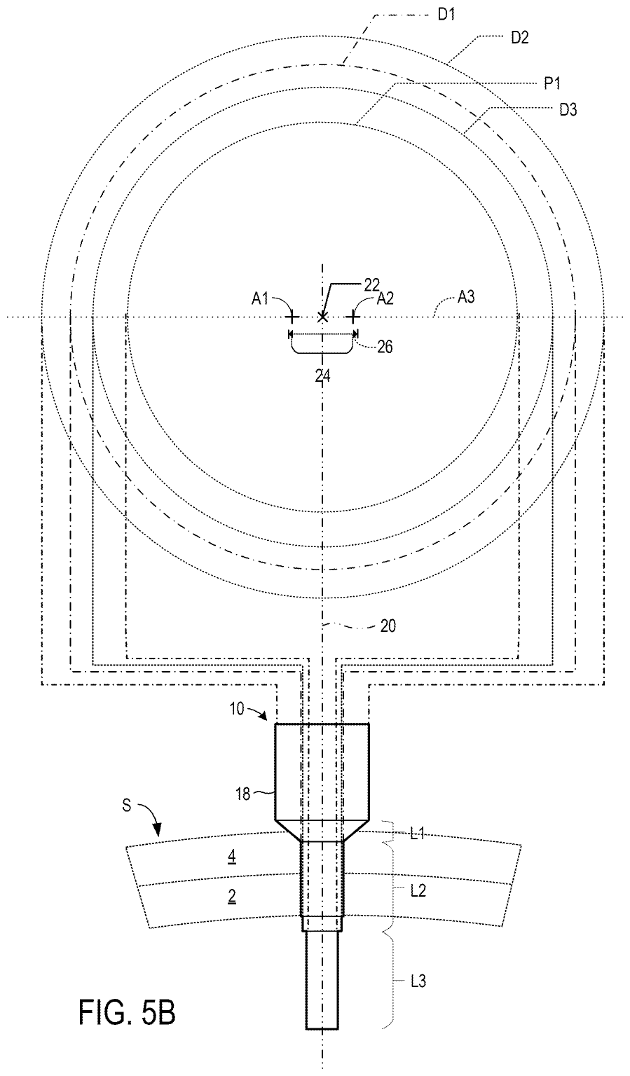

Referring to FIGS. 5A and 5B, schematic diagrams illustrate the relative sizes and positions of the first preformed hole 6a1, the second preformed hole 6a2, and the through-hole 5 relative to the pilot diameter P1, hole cutter outer diameter D1, countersink cutter outer diameter D2, and the hole cutter intermediate diameter D3 of the tool 10. The clearance 28 if any, the actual offset distance 24, and the maximum allowable offset distance 26 are schematically illustrated in relation to the dimensions of the tool 10 and the holes, including the first preformed hole 6a1, the second preformed hole 6a2, and the through-hole 5. If all temporary fasteners fit, it ensures that actual offset distance 24 is equal to or less than maximum allowable offset distance 26.

The pilot member 16 has a pilot diameter P1 smaller than the hole cutter outer diameter D1 and substantially equal to the preformed hole diameter H1 minus the maximum allowable offset distance 26. The pilot diameter P1 is sized to pass through the through-hole 5 within the clearance gap C, which is defined by a portion of a boundary 6a1′ of the first preformed hole 6a1 and at least a portion of a boundary 6a2′ of the second preformed hole 6a2, as discussed above. The hole cutter outer diameter D1 is greater than or equal to the preformed hole diameter H1 plus the maximum allowable offset distance 26.

In this example, the actual offset distance 24 between the first central axis A1 of the first preformed hole 6a1 and the second central axis A2 of the second preformed hole 6a2 is substantially equal to the maximum allowable offset distance 26. However, it will be appreciated that the actual offset distances of the multiple hole pairs can vary both in magnitude and in direction in a given stack-up. When the actual offset distance 24 is substantially equal to the maximum allowable offset distance 26, contact is achieved between side surfaces of the pilot member having the pilot diameter P1 and the through-hole 5 at two sides of the through-hole 5: between the boundary 6a2′ of the second preformed hole 6a2 and the pilot diameter P1, and between boundary 6a1′ of the first preformed hole 6a1 and the pilot diameter P1. On the other hand, when the actual offset distance 24 is less than the maximum allowable offset distance 26, a clearance 28 is realized between one or more of the sides of the pilot member and the sides of the through-hole. The clearance 28 can be as large as the maximum allowable offset distance 26, when the preformed holes are coaxial and the pilot member 16 contacts one of the through-hole sides but not the other.

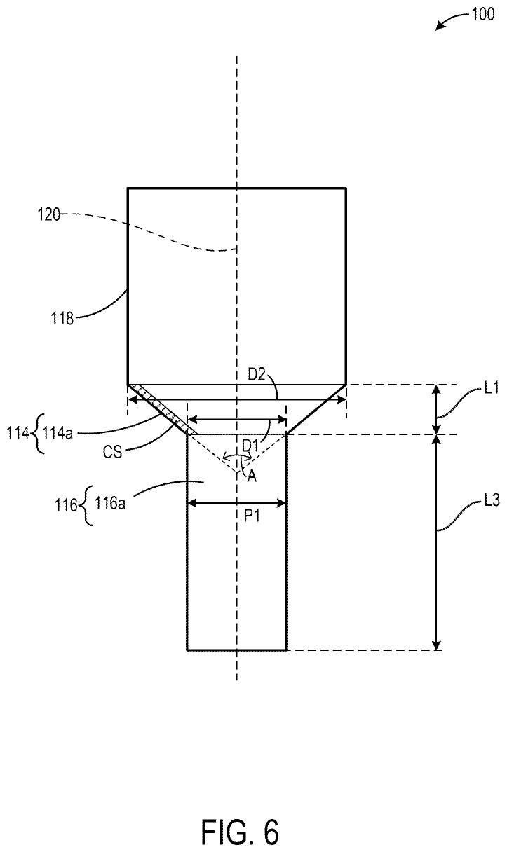

Referring to FIG. 6, a tool 100 is provided comprising a pilot member 116 and a countersink cutter 114, according to a second embodiment of the present disclosure. The pilot member 116 is formed adjacent the countersink cutter 114. The pilot member 116 is coaxial to the countersink cutter 114 along a centerline 120.

The countersink cutter 114 has a hole widening section 114a adjacent a body 118 of the tool 100. The hole widening section 114a is adjacent the pilot member 116, widening from the pilot diameter P1 to a countersink cutter outer diameter D2 larger than the pilot diameter P1. The hole widening section 114a has a hole widening section length L1 measured between the pilot member 116 and the body 118 of the tool 100. The hole widening section 114a can be partially conical in profile, with cutting surfaces formed at a countersink angle A centered on centerline 120. The countersink angle A can be in a range from 60-120 degrees, in one example. For example, specific countersink angle values of 60, 82, 90, 100, 110 and 120 degrees are possible. Alternatively, the hole widening section can have a curved profile or stepped profile (i.e., a profile with a right-angled step). Thus, the hole widening section can form a recess that accommodates fastener heads of the final fasteners 9 that are tapered, curved, or cylindrical.

It will be appreciated that surface 114a forms a cutting surface CS of the tool 10. The cutting surface CS can be fluted with a suitable number of flutes such as one, two, three of more flutes. Each flute terminates in a cutting surface at a distal end. The body 118 can have dimensions suitable for insertion into a chuck, and thus it will be appreciated that body 118 can include a change in width (via a step or taper) from D2 to a width that is insertable into a desired chuck. The circumferential surface of the body 18 is smooth and does not include a cutting surface. The countersink cutter 114 is formed coaxially with the pilot member 116 along the centerline 120.

The pilot member 116 has a pilot diameter P1 and includes a cylindrical shaft 116a. The shaft 116a typically includes a smooth external surface and is devoid of a cutting surface, but can be fluted in some examples. A pilot length L3 of the pilot member 116 is measured along the centerline 120 from the hole widening section 114a of the countersink cutter 114. The countersink cutter outer diameter D2 of the countersink cutter 114 is larger than the pilot diameter P1.

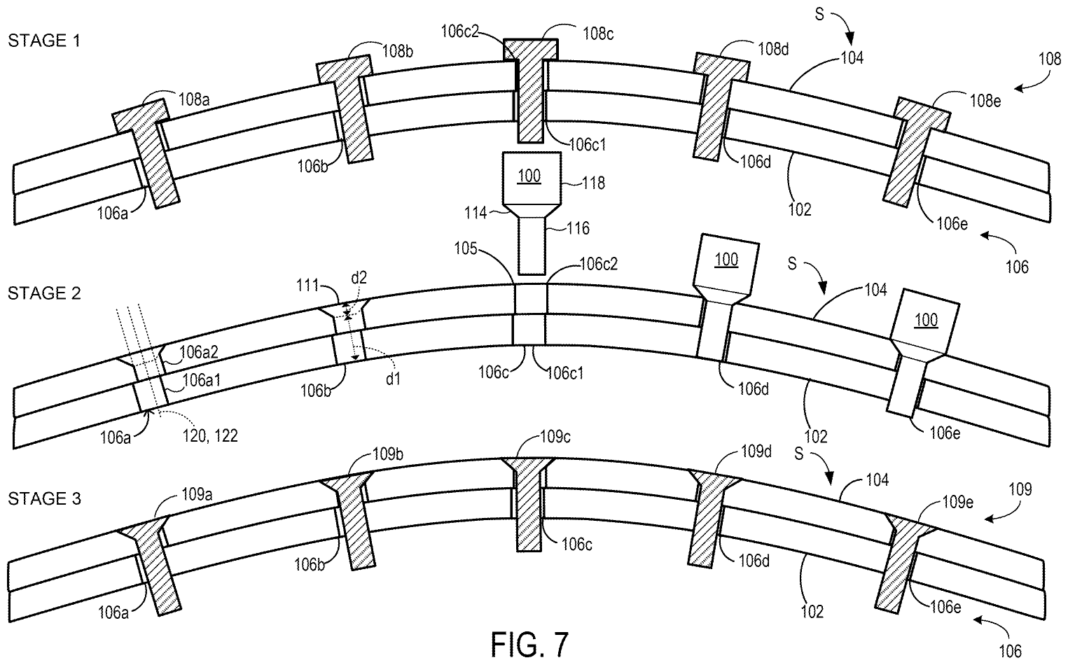

Referring to FIG. 7, a schematic diagram is provided, illustrating three stages of joining a first component 102 and a second component 104 together according to the second embodiment of the present disclosure. A plurality of preformed holes 106a-106e are in respective stacked components (first component 102 and second component 104) of a stack-up S overlapped in fixed positional relation to each other. A through-hole is formed through an overlapping region of the preformed holes 106a-106e. The stacked components 102, 104 can be layers in a stack-up that can be flat or can be curved according to a curvature.

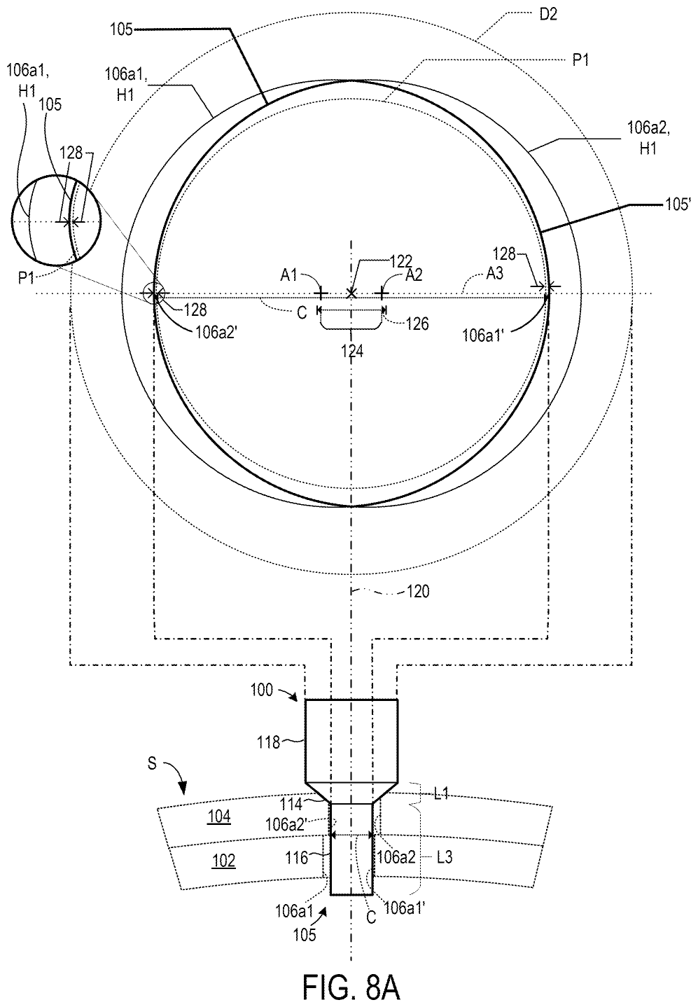

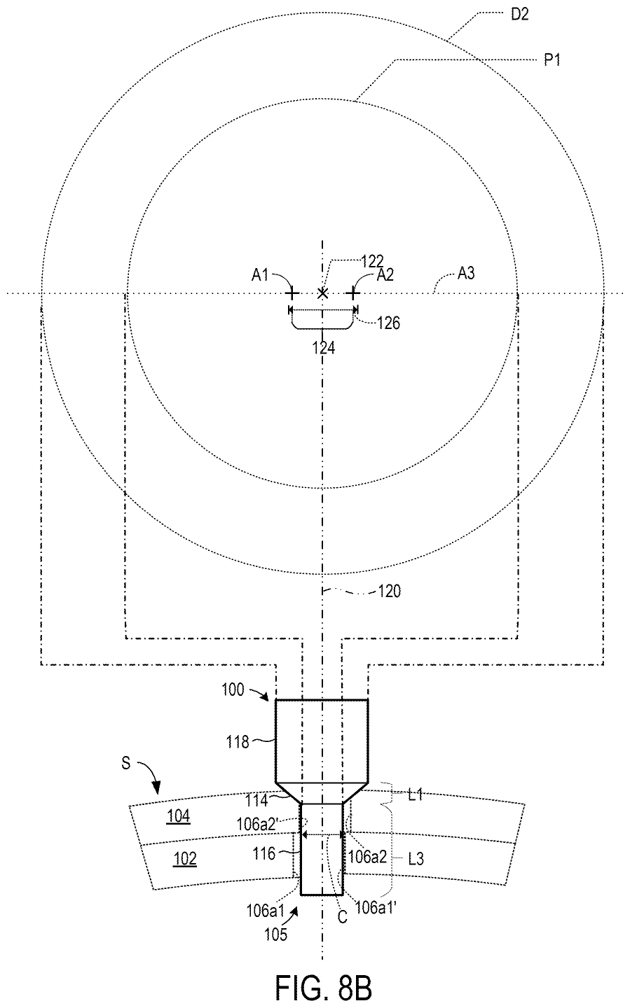

The tool 100 is provided for creating a countersink hole 111 from a first preformed hole 106c1 and a second preformed hole 106c2 in respective stacked components. The first preformed hole 106c1 and the second preformed hole 106c2 have a preformed hole diameter and is offset by an offset distance less than or equal to a maximum allowable offset distance 126 (see FIG. 8) so as to be at least partially overlapped in fixed positional relation to each other. A through-hole is formed through an overlapping region of the preformed holes 106c1, 106c2.

In stage 1, a temporary fastener 108 is selected having a shaft diameter that is equal to the diameter of the final fastener 109, then the temporary fasteners 108a-108e are inserted through the through-holes of the preformed holes 106a-106e to temporarily secure the first component 102 and the second component 104 together. In stage 2, the tool 100 is inserted into the through-hole 105 formed by the overlap of holes 106c1 and 106c2 to fit the pilot member 116 in the through-hole 105 such that the pilot member 116 passes between and typically contacts at least one of a first side of the first preformed hole 106c1 or an opposite side of the second preformed hole 106c2 to extend through all parts to be joined by the final fastener 109, and thereby position the axis 122 centered between an axis of the first preformed hole 106c1 and an axis of the second preformed hole 106c2, when the pilot member 116 is inserted in the through-hole 105.

A countersink hole 111 is subsequently formed in the full-sized hole 106c by further advancing the tool 100 a second predetermined distance d2 under rotation into the through-hole 105 to cause the countersink cutter 114 to cut the countersink hole 111 centered between the first side of the first preformed hole 106c1 and an opposite side of the second preformed hole 106c2. In stage 3, final fasteners 109a-109e are installed into the preformed holes 106a-106e with countersink holes 111 to join the first component 102 and the second component 104 together.

Accordingly, since the pilot member 116 extends through all the stacked components 102 and 104, the countersink hole 111 that is produced by the countersink cutter 114 is centered not only on the preformed hole 106c in the second component 104, but also on the preformed hole 106c in the first component 102. Thus, center axis 120 of the tool 100 is positioned substantially coaxial with axis 122 of the through-hole when inserted, which forms the countersink hole 111 centered on the axis 122. Since the final fastener 109 typically contacts one or more of the side walls of the through hole when installed in a parallel orientation, stress concentrations can be avoided, for both smooth and threaded fasteners, as discussed in relation to the embodiment above. Further, the heads of the final fasteners 109a-109e are snugly seated circumferentially inside the countersink holes 111, thereby facilitating a secure connection. These factors promote strength and longevity of the connection.

Referring to FIGS. 8A and 8B, schematic diagrams illustrate the sizes and positions of the first preformed hole 106a1, the second preformed hole 106a2, and the through-hole 105 relative to the pilot diameter P1 and the countersink cutter outer diameter D2 of the tool 100. The clearance 128 if any, the actual offset distance 124, and the maximum allowable offset distance 126 are schematically illustrated in relation to the dimensions of the tool 100 and the holes, including the first preformed hole 106a1, the second preformed hole 106a2, and the through-hole 105. The temporary fasteners are sized to have a shaft diameter that equal to the maximum allowable offset distance. Thus, if all temporary fasteners fit in the through-holes, it ensures that actual offset distance 124 is equal to or less than maximum allowable offset distance 126.

The pilot member 116 is configured to contact a first side of the first preformed hole 106a1 and an opposite side of the second preformed hole 106a2 at respective locations where a major axis A3 of the first preformed hole 106a1 and the second preformed hole 106a2 intersects the non-cylindrical perimeter 105′ of the through-hole 105, to thereby position an axis 122 centered between an axis A1 of the first preformed hole 106a1 and an axis A2 of the second preformed hole 106a2, when the pilot member 116 is inserted in the through-hole 105, and the actual offset distance 24 is equal to the maximum allowable offset distance 26. Where the actual offset distance 124 is less than the maximum allowable offset distance 126 only one side, or possibly neither side of the pilot member contacts the sides of the preformed holes 106a1, 106a2. Nevertheless, in typical applications, the size of the pilot member 116 is chosen so that at least one side of the through-hole 105 is contacted by the pilot member 116.

Specifically, the pilot member 116 has a pilot diameter P1 that is selected to be within a maximum allowable fit tolerance of a distance equal to the preformed hole diameter minus the maximum allowable offset distance 126. The pilot diameter P1 is sized to pass through the through-hole 105 within the clearance gap C, which is defined by a portion of a boundary 106a1′ of the first preformed hole 106a1 and at least a portion of a boundary 106a2′ of the second preformed hole 106a2, and may contact either or both of these boundaries. It will be appreciated that even when neither side is contacted, the countersink hole 111, discussed in relation to FIG. 7, centers the final fastener 109 within the through-hole 105, and orients the pilot member 116 to be parallel with the axis 122 of the through-hole 105, and with the opposing boundaries 106a1′, 106a2′.

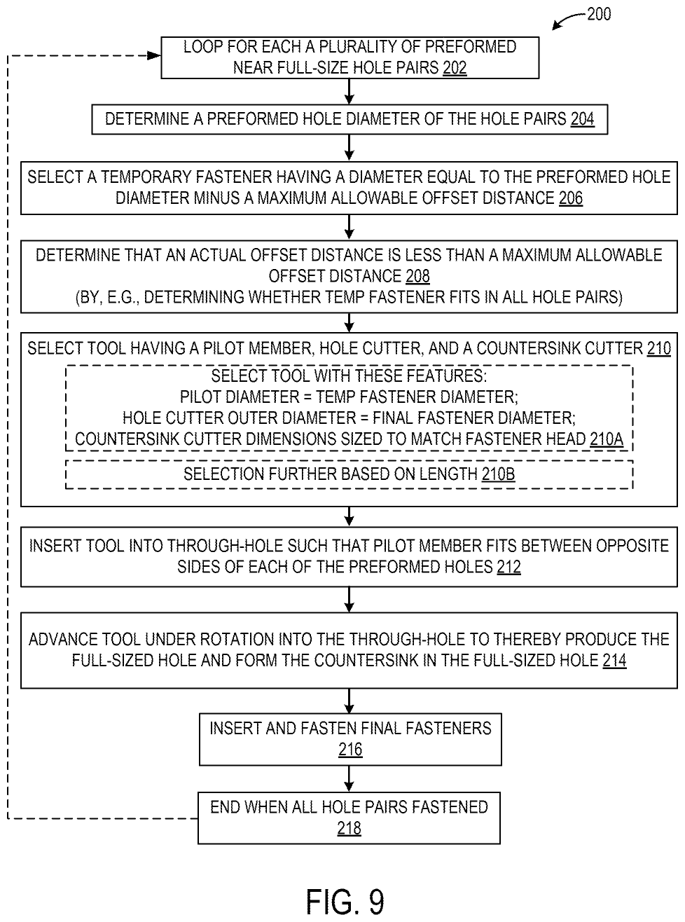

Referring to FIG. 9, a method 200 is provided for creating a full-sized hole with countersink from a pair of preformed holes 6a1, 6a2 that are near full-size and that are in respective stacked components 2, 4 of a stack-up S. The preformed holes 6a1, 6a2 are overlapped in fixed positional relation to each other. A through-hole 5 is formed through an overlapping region of the preformed holes 6a1, 6a2. Method 200 can be performed using tool 10 of the first embodiment described above.

At 202, method 200 includes looping through steps 204-216 for each of a plurality of pairs of preformed near-sized holes 6a1, 6a2 in a stack-up S of respective components. At step 204, a preformed hole diameter H1 of the preformed holes 6a1, 6a2 is determined, for example by inspection, measurement, or reference to a design specification used to produce the stack-up S. Typically, the preformed hole diameter H1 is the same for each of the near full-sized preformed holes in the stack-up S, but alternatively the preformed holes may be organized into sub-groups each having the same preformed hole diameter.

It will be appreciated that the plurality of pairs of holes 6a1, 6a2 may be misaligned for the reasons discussed above. To address this, at step 206, the method 200 includes selecting a temporary fastener 8a having a shaft diameter that is equal to the determined preformed hole diameter H1 minus the maximum allowable offset distance. At 208, it is determined that an actual offset distance 24 between the pair of preformed holes 6a1, 6a2 is equal to or less than a maximum allowable offset distance 26 by inserting the selected temporary fastener. It will be appreciated that the selected temporary fastener is specifically sized to ensure that near full-sized hole clean up (i.e., boring out) can be successfully carried out to achieve the full-sized hole diameter. As the method 200 loops through step 208 for each hole pair, it will be appreciated that step 208 can include determining, for each of multiple preformed hole pairs of the plurality of preformed holes in the respective stacked components 2, 4 of the stack-up S, that the corresponding actual offset distance 24 for each hole pair is less than or equal to the maximum allowable offset distance 26.

At step 210, a tool 10 is selected for creating the countersink full-sized hole 7a-7e, the tool 10 having a coaxial pilot member 16, hole cutter 12, and countersink cutter 14. The tool 10 is selected to have a pilot diameter P1 that is equal to preformed hole diameter H1 minus the maximum allowable offset distance 26, and such that the hole cutter 12 has a hole cutter outer diameter D1 that is larger than the pilot diameter P1, and further such that the hole cutter outer diameter D1 is greater than or equal to the preformed hole diameter H1 plus the maximum allowable offset distance 26. At 210A, the tool may be selected such that the pilot member diameter P1 is equal to the temporary fastener shaft diameter, and such that the hole cutter outer diameter D1 of the hole cutter equals a shaft diameter of the final fastener 9. Also at 210A, the tool may be selected such that dimensions of the countersink cutter 14, including a countersink angle A, match the fastener head of the final fastener 9. In this manner the final fastener 9 can be flush or recessed and fully seated within the countersink hole 11 when installed. At 210B, the method 200 may further include selecting the tool 10 based on the thickness of the stack-up S of components, to ensure that lengths of the pilot member 16 and hole cutter 12 are sufficient to pass through all components of the stack-up S when inserted.

At step 212, the tool 10 is inserted into the through-hole 5 to fit the pilot member 16 in the through-hole 5 so that it fits between opposite sides of the preformed holes 6a1, 6a2 and passes all the way through all of the components in the stack.

At step 214, the preformed holes 6a1, 6a2 are bored out with the hole cutter 12 of the tool 10 by advancing the tool 10 at least a predetermined distance under rotation into the through-hole 5 to thereby produce the full-sized hole 7 and form the countersink in the full-sized hole. The predetermined distance is a distance sufficient to cause the hole cutter to pass completely through all components in the stack, and to cause the countersink cutter 14 to cut to a depth sufficient to enable a head of the final fastener 9 head to sit recessed or flush with a topmost surface of the stack-up S when installed. The full-sized hole 7a circumscribes or encompasses the pair of preformed holes 6a1, 6a2 at the conclusion of step 214.

At 216, the method 200 includes inserting a final fastener 9 into the full-sized hole, the final fastener 9 having a shaft diameter that is substantially equal to (i.e., equal to or slightly undersized to ensure a fit tolerance) the diameter of the hole cutter 12 (and also the diameter of the full-sized hole 7), and securing the final fastener 9. The final fastener 9 may be a threaded fastener such as a screw or bolt and the full-sized hole may have threads cut into its walls. Alternatively, the final fastener 9 may be smooth at least in a region passing through the components in the stack-up S, such as a bolt with a smooth middle section, or a rivet. At 218, it is determined whether all of the hole pairs have been fastened in this manner. If not, the method 200 loops back to step 202, and if so the method 200 ends.

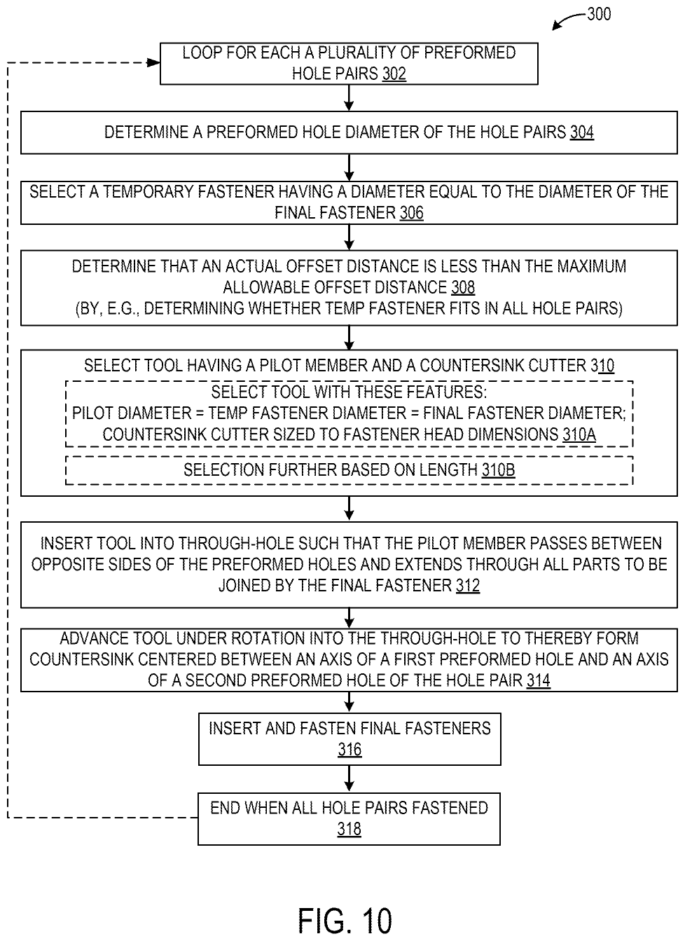

Referring to FIG. 10, a method 300 is provided for creating a countersink hole 111 from a first preformed hole 106a1 and a second preformed hole 106a2 positioned in respective stacked components 102, 104 so as to be at least partially overlapped in fixed positional relation to each other. A through-hole 105 is formed through an overlapping region of the preformed holes 106a1, 106a2. It will be appreciated that the preformed holes 106a1, 106a2 may be misaligned. Method 300 is performed using tool 100 of the second embodiment in view of this misalignment.

At step 302, method 300 includes looping through steps 304-316 for each of a plurality of pairs of preformed holes 106a1, 106a2 in a stack-up S of respective components. At step 304, a preformed hole diameter H1 of the first and second full-sized preformed holes 106a1, 106a2 is determined, for example by inspection, measurement, or reference to a design specification used to produce the stack-up S. Typically, the preformed hole diameter H1 is the same for each of the preformed holes in the stack-up S, but alternatively the preformed holes may be organized into sub-groups each having the same preformed hole diameter. At step 306, the method 300 includes selecting a temporary fastener 108a having a shaft diameter that is equal to the diameter of the final fastener 109a. At step 308, it is determined that an actual offset distance 124 of the first and second preformed holes 106a1, 106a2 is less than a maximum allowable offset distance 126 by inserting a temporary fastener 108a to ensure fit of the final fastener 109a. It will be appreciated that as the method 300 loops through each hole pair, determining at step 308 may include, for each of multiple preformed hole pairs of the plurality of preformed holes 106a1, 106a2 in the respective stacked components 102, 104 of the stack-up S, that the corresponding actual offset distance 124 for each hole pair is less than or equal to the maximum allowable offset distance 126, by determining whether temporary fasteners 108 fit in each hole pair.

At step 310, the method 300 includes selecting a tool 100 for creating a countersink hole 111, the tool 100 being selected to have a pilot member 116 and a countersink cutter 114. At 310A, the tool can be selected such that the pilot member 116 has a pilot diameter P1 that is equal to a diameter of the temporary fastener 108a shaft diameter, and that is also equal to the final fastener 109a shaft diameter. The selected tool can have a countersink cutter 114 having a hole widening section 114a widening from a countersink cutter outer diameter D2 larger than the pilot diameter P1 to the pilot diameter P1, and being formed coaxial with the pilot member 116. The tool 100 can be selected such that the dimensions of the counter sink cutter 114, such as the countersink angle A, are sized to match the head dimensions of the final fastener 109a. At 310B, the tool 100 can be selected to have a length sufficient to ensure that the pin extends completely through the through-hole.

At step 312, the tool 100 is inserted into the through-hole 105 to fit the pilot member 116 in the through-hole 105 such that the pilot member passes through opposite sides of the first preformed hole and second preformed hole and extends through all parts to be joined by the final fastener 109.

At step 314, the method 300 includes further advancing the tool 100 under rotation into the through-hole 105 to cause the countersink cutter 114 to form the countersink hole 111 centered between an axis of the first preformed hole 106a1 and an axis of the second preformed hole 106a2. At step 316, the method 300 further includes inserting final fasteners 109 into the through-hole with the countersink hole 111 formed therein, and fastening the final fastener 109. At 318, the method 300 includes determining whether all hole pairs have been fastened at 316, at which point the method 300 ends. If any hole pairs remain to be fastened, the method 300 loops back to 302. It will be appreciated that the countersink hole 111 made according to method 302 promotes alignment of the axis of the final fastener 109 along the axis 122 of the through-hole 105 centered between the axis of the first preformed hole 106a1 and the axis of the second preformed hole 106a2, thereby avoiding stress concentrations due to misalignment and facilitating a strong and long-lasting connection.

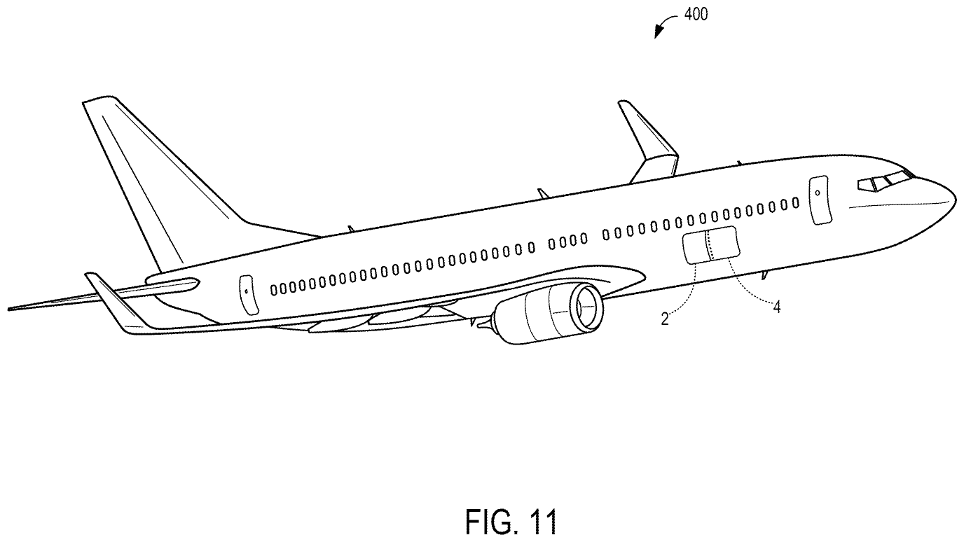

FIG. 11 is a schematic illustration of an exemplary vehicle in the form of an aircraft 400 in accordance with the embodiments and examples according to the subject disclosure. It will be appreciated that the first component 2 and the second component 4 described in FIG. 2 can be a body panel on the aircraft 400, as one particular non-limiting example.

Using the above-described tools and methods, stacked components having patterns of preformed holes therein can be securely fastened together final fasteners having flush or recessed fastener heads, despite the existence of actual offset distances between certain pairs of the holes, within a maximum allowable offset distance. According to the first embodiment, a tool 10 is used to bore out near full-sized holes 6a-6e to form the finished full-sized holes (aligned holes) 7a-7e and form a countersink through which the final fasteners 9a-9e are inserted. According to the second embodiment, a tool 100 is provided to create a countersink hole 111 on a through-hole 105 formed between two overlapping preformed holes 106a1, 106a2. In accordance with the above-described tools and methods countersink holes can be aligned with the shanks of the fasteners that are installed therein, so that the heads of the fasteners can engage flush or recessed inside the countersink holes thereby resulting in improved load transfer resulting in a connection with strength and longevity, which improves performance and lifecycle when installed in a vehicle.

The subject disclosure includes all novel and non-obvious combinations and subcombinations of the various features and techniques disclosed herein. The various features and techniques disclosed herein are not necessarily required of all examples of the subject disclosure. Furthermore, the various features and techniques disclosed herein can define patentable subject matter apart from the disclosed examples and can find utility in other implementations not expressly disclosed herein.

To the extent that terms “includes,” “including,” “has,” “contains,” and variants thereof are used herein, such terms are intended to be inclusive in a manner similar to the term “comprises” as an open transition word without precluding any additional or other elements.

Further, the disclosure comprises configurations according to the following clauses.
Clause 1. A tool for creating a full-sized hole and countersink from a plurality of preformed holes that are near full-size and that are in respective stacked components of a stack-up overlapped in fixed positional relation to each other, a through-hole being formed through an overlapping region of the preformed holes, each preformed hole having a preformed hole diameter and an offset distance less or equal to a maximum allowable offset distance, the tool comprising: a hole cutter having a hole cutter outer diameter; a countersink cutter with a hole widening section adjacent the hole cutter, the hole widening section widening from the hole cutter outer diameter to a countersink cutter outer diameter larger than the hole cutter outer diameter; and a pilot member formed adjacent the hole cutter, the pilot member being coaxial to the hole cutter and the countersink cutter, the pilot member having a pilot diameter smaller than the hole cutter outer diameter and substantially equal to the preformed hole diameter minus the maximum allowable offset distance, the pilot diameter being sized to pass through the through-hole, wherein the hole cutter outer diameter is greater than or equal to the preformed hole diameter plus the maximum allowable offset distance.
Clause 2. The tool of clause 1, wherein the plurality of preformed holes includes a first preformed hole and a second preformed hole and wherein at least a portion of a boundary of the first preformed hole and at least a portion of a boundary of the second preformed hole define a non-cylindrical perimeter of the through-hole, the pilot member configured to contact a first side and an opposite side at respective locations where a major axis of the first preformed hole and the second preformed hole intersects the non-cylindrical perimeter.
Clause 3. The tool of any of clauses 1 or 2, wherein the maximum allowable offset distance defines a predefined maximum distance between a center of each of the first preformed hole and the second preformed hole.
Clause 4. The tool of any of clauses 1 to 3, wherein the pilot member includes a cylindrical shaft.
Clause 5. The tool of any of clauses 1 to 4, wherein the hole cutter further comprises a first stepped section and a second stepped section, the second stepped section having the hole cutter outer diameter, and the first stepped section has a hole cutter intermediate diameter smaller than the hole cutter outer diameter.
Clause 6. The tool of any of clauses 1 to 5, wherein the hole cutter intermediate diameter is larger than the pilot diameter.
Clause 7. A method for creating a full-sized hole and countersink from a pair of preformed holes that are near full-size and that are in respective stacked components of a stack-up, the preformed holes being overlapped in fixed positional relation to each other, a through-hole being formed through an overlapping region of the preformed holes, the method comprising: determining a preformed hole diameter of the preformed holes; determining that an actual offset distance between the pair of preformed holes is less than a maximum allowable offset distance; selecting a tool for creating the full-sized hole, the tool having a coaxial pilot member and a hole cutter, the tool being selected to have a pilot diameter that is equal to the preformed hole diameter minus the maximum allowable offset distance, the hole cutter having a hole cutter outer diameter that is larger than the pilot diameter, the hole cutter outer diameter being greater than or equal to the preformed hole diameter plus the maximum allowable offset distance, the tool further including a countersink cutter having a countersink cutter diameter that widens from the hole cutter outer diameter to a countersink cutter outer diameter larger than the hole cutter outer diameter; inserting the tool into the through-hole to fit the pilot member in the through-hole such that the pilot member passes between opposite sides of each of the preformed holes; advancing the tool under rotation into the through-hole to thereby bore out the preformed holes with the hole cutter of the tool to produce the full-sized hole, and to form a countersink in the full-sized hole with the countersink cutter, the full-sized hole circumscribing or encompassing the pair of preformed holes.
Clause 8. The method of clause 7, wherein the pair of preformed holes includes a first preformed hole and a second preformed hole and wherein at least a portion of a boundary of the first preformed hole and at least a portion of a boundary of the second preformed hole define a non-cylindrical perimeter of the through-hole, the pilot member fitting in the through-hole to contact a first side and an opposite side at respective locations where a major axis of the first preformed hole and the second preformed hole intersects the non-cylindrical perimeter.
Clause 9. The method of any of clauses 7 or 8, wherein the maximum allowable offset distance defines a predefined maximum distance between a center of each of the first preformed hole and the second preformed hole.
Clause 10. The method of any of clauses 7 to 9, further comprising: prior to selecting the tool for creating the full-sized hole: selecting a temporary fastener having a shaft diameter equal to the preformed hole diameter minus the maximum allowable offset, wherein determining that the actual offset distance is less than the maximum allowable offset distance includes determining that the temporary fastener can be inserted and pass through the through-hole; and after advancing the tool to produce the full-sized hole and form the countersink: selecting a final fastener having a final fastener shaft diameter that is equal to the hole cutter outer diameter of the hole cutter; inserting the final fastener into the through-hole and the countersink; and fastening the final fastener.
Clause 11. The method of any of clauses 7 to 10, wherein the hole cutter further comprises a first stepped section and a second stepped section, the second stepped section having the hole cutter outer diameter, and the first stepped section having a hole cutter intermediate diameter smaller than the hole cutter outer diameter, and the hole cutter is selected so that the hole cutter intermediate diameter is larger than the pilot diameter and smaller than the countersink cutter diameter.
Clause 12. The method of any of clauses 7 to 11, wherein the pair of preformed holes includes multiple preformed hole pairs in the respective stacked components of the stack-up, each hole pair having a corresponding actual offset distance, and determining that the actual offset distance is less than the maximum allowable offset distance includes determining for each of the hole pairs that the corresponding actual offset distance is less than the maximum allowable offset distance.
Clause 13. The method of any of clauses 7 to 12, wherein the stacked components are layers in a stack-up that is curved according to a curvature, actual offset distances of the multiple hole pairs vary, and the actual offset distance of each hole pair is caused at least in part by a relative lateral shift in the layers at a location of the hole pair due to the curvature.
Clause 14. A tool for creating a countersink hole from a first preformed hole and a second preformed hole in respective stacked components, the first preformed hole and the second preformed hole having a preformed hole diameter and being offset by an offset distance less than or equal to a maximum allowable offset distance so as to be at least partially overlapped in fixed positional relation to each other, a through-hole being formed through an overlapping region of the preformed holes, the tool comprising: a pilot member having a pilot diameter that is equal to the preformed hole diameter minus the maximum allowable offset distance; and a countersink cutter with a hole widening section widening from the pilot diameter to a countersink cutter outer diameter larger than the pilot diameter, and being formed coaxial with the pilot member; wherein the pilot member is configured to contact at least one of a first side of the first preformed hole or an opposite side of the second preformed hole to thereby position a central axis of the tool centered between an axis of the first preformed hole and an axis of the second preformed hole, when the pilot member is inserted in the through-hole.
Clause 15. The tool of clause 14, wherein at least a portion of a boundary of the first preformed hole and at least a portion of a boundary of the second preformed hole define a non-cylindrical perimeter of the through-hole, and when the pilot member is inserted into the through-hole, the pilot member contacts the first side and the opposite side at respective locations where a major axis of the first preformed hole and the second preformed hole intersects the non-cylindrical perimeter.
Clause 16. The tool of any of clauses 14 or 15, wherein the pilot member includes a cylindrical shaft.
Clause 17. A method for creating a countersink hole from a first preformed hole and a second preformed hole in respective stacked components so as to be at least partially overlapped in fixed positional relation to each other, a through-hole being formed through an overlapping region of the preformed holes, the method comprising: determining a preformed hole diameter of the first preformed hole and the second preformed hole; determining that an offset distance of the first preformed hole and the second preformed hole is less than a maximum allowable offset distance; selecting a tool for creating the countersink hole, the tool having a pilot member and a countersink cutter, the pilot member having a pilot diameter that is equal to the preformed hole diameter minus the maximum allowable offset distance, and the countersink cutter having a hole widening section widening from the pilot diameter to a countersink cutter outer diameter larger than the pilot diameter, and being formed coaxial with the pilot member; inserting the tool into the through-hole to fit the pilot member in the through-hole such that the pilot member contacts at least one of a first side of the first preformed hole or an opposite side of the second preformed hole to thereby align a central axis of the tool to be centered between an axis of the first preformed hole and an axis of the second preformed hole, when the pilot member is inserted in the through-hole; and advancing the tool under rotation into the through-hole to cause the countersink cutter to form a countersink centered between the axis of the first preformed hole and the axis of the second preformed hole.
Clause 18. The method of clause 17, wherein at least a portion of a boundary of the first preformed hole and at least a portion of a boundary of the second preformed hole define a non-cylindrical perimeter of the through-hole, and when the pilot member is inserted into the through-hole, the pilot member contacts the first side and the opposite side at respective locations where a major axis of the first preformed hole and the second preformed hole intersects the non-cylindrical perimeter.
Clause 19. The method of any of clauses 17 or 18, the method further comprising: prior to selecting a tool for creating the countersink hole: selecting a temporary fastener having a shaft diameter equal to the preformed hole diameter minus the maximum allowable offset, wherein determining that an actual offset distance is less than the maximum allowable offset distance includes determining that the temporary fastener can be inserted and pass through the through-hole; and after advancing the tool to form the countersink: selecting a final fastener having a final fastener shaft diameter that is equal to the pilot diameter; inserting the final fastener into the through-hole and the countersink; and fastening the final fastener.
Clause 20. The method of any of clauses 17 to 19, wherein the first preformed hole and the second preformed hole form a first preformed hole pair of multiple preformed hole pairs in a stack-up of the respective stacked components, each hole pair having a corresponding actual offset distance, and determining that the actual offset distance is less than the maximum allowable offset distance includes determining for each of the hole pairs that the corresponding actual offset distance is less than or equal to the maximum allowable offset distance.
Clause 21. The method of any of clauses 17 to 20, wherein the stacked components are layers in the stack-up that are curved according to a curvature, the actual offset distances of the multiple hole pairs vary, and the actual offset distance of each hole pair is caused at least in part by a relative lateral shift in the layers at a location of the hole pair due to the curvature.

1. A tool for creating a full-sized hole and countersink from a plurality of preformed holes that are near full-size and that are in respective stacked components of a stack-up overlapped in fixed positional relation to each other, a through-hole being formed through an overlapping region of the preformed holes, each preformed hole having a preformed hole diameter and an offset distance less or equal to a maximum allowable offset distance, the tool comprising:
a hole cutter having a hole cutter outer diameter;
a countersink cutter with a hole widening section adjacent the hole cutter, the hole widening section widening from the hole cutter outer diameter to a countersink cutter outer diameter larger than the hole cutter outer diameter; and
a pilot member formed adjacent the hole cutter, the pilot member being coaxial to the hole cutter and the countersink cutter, the pilot member having a pilot diameter smaller than the hole cutter outer diameter and substantially equal to the preformed hole diameter minus the maximum allowable offset distance, the pilot diameter being sized to pass through the through-hole,
wherein the hole cutter outer diameter is greater than or equal to the preformed hole diameter plus the maximum allowable offset distance.

2. The tool of claim 1, wherein the plurality of preformed holes includes a first preformed hole and a second preformed hole and wherein at least a portion of a boundary of the first preformed hole and at least a portion of a boundary of the second preformed hole define a non-cylindrical perimeter of the through-hole, the pilot member configured to contact a first side and an opposite side at respective locations where a major axis of the first preformed hole and the second preformed hole intersects the non-cylindrical perimeter.

3. The tool of claim 2, wherein the maximum allowable offset distance defines a predefined maximum distance between a center of each of the first preformed hole and the second preformed hole.

4. The tool of claim 1, wherein the pilot member includes a cylindrical shaft.

5. The tool of claim 1, wherein the hole cutter further comprises a first stepped section and a second stepped section, the second stepped section having the hole cutter outer diameter, and the first stepped section has a hole cutter intermediate diameter smaller than the hole cutter outer diameter.

6. The tool of claim 5, wherein the hole cutter intermediate diameter is larger than the pilot diameter.

7. A method for creating a full-sized hole and countersink from a pair of preformed holes that are near full-size and that are in respective stacked components of a stack-up, the preformed holes being overlapped in fixed positional relation to each other, a through-hole being formed through an overlapping region of the preformed holes, the method comprising:
determining a preformed hole diameter of the preformed holes;
determining that an actual offset distance between the pair of preformed holes is less than a maximum allowable offset distance;
selecting a tool for creating the full-sized hole, the tool having a coaxial pilot member and a hole cutter, the tool being selected to have a pilot diameter that is equal to the preformed hole diameter minus the maximum allowable offset distance, the hole cutter having a hole cutter outer diameter that is larger than the pilot diameter, the hole cutter outer diameter being greater than or equal to the preformed hole diameter plus the maximum allowable offset distance, the tool further including a countersink cutter having a countersink cutter diameter that widens from the hole cutter outer diameter to a countersink cutter outer diameter larger than the hole cutter outer diameter;
inserting the tool into the through-hole to fit the pilot member in the through-hole such that the pilot member passes between opposite sides of each of the preformed holes;
advancing the tool under rotation into the through-hole to thereby bore out the preformed holes with the hole cutter of the tool to produce the full-sized hole, and to form a countersink in the full-sized hole with the countersink cutter, the full-sized hole circumscribing or encompassing the pair of preformed holes.

8. The method of claim 7, wherein the pair of preformed holes includes a first preformed hole and a second preformed hole and wherein at least a portion of a boundary of the first preformed hole and at least a portion of a boundary of the second preformed hole define a non-cylindrical perimeter of the through-hole, the pilot member fitting in the through-hole to contact a first side and an opposite side at respective locations where a major axis of the first preformed hole and the second preformed hole intersects the non-cylindrical perimeter.

9. The method of claim 8, wherein the maximum allowable offset distance defines a predefined maximum distance between a center of each of the first preformed hole and the second preformed hole.

10. The method of claim 7, further comprising:
prior to selecting the tool for creating the full-sized hole:
selecting a temporary fastener having a shaft diameter equal to the preformed hole diameter minus the maximum allowable offset,
wherein determining that the actual offset distance is less than the maximum allowable offset distance includes determining that the temporary fastener can be inserted and pass through the through-hole; and
after advancing the tool to produce the full-sized hole and form the countersink:
selecting a final fastener having a final fastener shaft diameter that is equal to the hole cutter outer diameter of the hole cutter;
inserting the final fastener into the through-hole and the countersink; and
fastening the final fastener.

11. The method of claim 7, wherein
the hole cutter further comprises a first stepped section and a second stepped section, the second stepped section having the hole cutter outer diameter, and the first stepped section having a hole cutter intermediate diameter smaller than the hole cutter outer diameter, and
the hole cutter is selected so that the hole cutter intermediate diameter is larger than the pilot diameter and smaller than the countersink cutter diameter.

12. The method of claim 7, wherein
the pair of preformed holes includes multiple preformed hole pairs in the respective stacked components of the stack-up, each hole pair having a corresponding actual offset distance, and
determining that the actual offset distance is less than the maximum allowable offset distance includes determining for each of the hole pairs that the corresponding actual offset distance is less than the maximum allowable offset distance.

13. The method of claim 12, wherein
the stacked components are layers in a stack-up that is curved according to a curvature,
actual offset distances of the multiple hole pairs vary, and
the actual offset distance of each hole pair is caused at least in part by a relative lateral shift in the layers at a location of the hole pair due to the curvature.

14. A tool for creating a countersink hole from a first preformed hole and a second preformed hole in respective stacked components, the first preformed hole and the second preformed hole having a preformed hole diameter and being offset by an offset distance less than or equal to a maximum allowable offset distance so as to be at least partially overlapped in fixed positional relation to each other, a through-hole being formed through an overlapping region of the preformed holes, the tool comprising:
a pilot member having a pilot diameter that is equal to the preformed hole diameter minus the maximum allowable offset distance; and
a countersink cutter with a hole widening section widening from the pilot diameter to a countersink cutter outer diameter larger than the pilot diameter, and being formed coaxial with the pilot member;
wherein the pilot member is configured to contact at least one of a first side of the first preformed hole or an opposite side of the second preformed hole to thereby position a central axis of the tool centered between an axis of the first preformed hole and an axis of the second preformed hole, when the pilot member is inserted in the through-hole.

15. The tool of claim 14, wherein
at least a portion of a boundary of the first preformed hole and at least a portion of a boundary of the second preformed hole define a non-cylindrical perimeter of the through-hole, and
when the pilot member is inserted into the through-hole, the pilot member contacts the first side and the opposite side at respective locations where a major axis of the first preformed hole and the second preformed hole intersects the non-cylindrical perimeter.

16. The tool of claim 14, wherein the pilot member includes a cylindrical shaft.

17. A method for creating a countersink hole from a first preformed hole and a second preformed hole in respective stacked components so as to be at least partially overlapped in fixed positional relation to each other, a through-hole being formed through an overlapping region of the preformed holes, the method comprising:
determining a preformed hole diameter of the first preformed hole and the second preformed hole;
determining that an offset distance of the first preformed hole and the second preformed hole is less than a maximum allowable offset distance;
selecting a tool for creating the countersink hole, the tool having a pilot member and a countersink cutter, the pilot member having a pilot diameter that is equal to the preformed hole diameter minus the maximum allowable offset distance, and the countersink cutter having a hole widening section widening from the pilot diameter to a countersink cutter outer diameter larger than the pilot diameter, and being formed coaxial with the pilot member;
inserting the tool into the through-hole to fit the pilot member in the through-hole such that the pilot member contacts at least one of a first side of the first preformed hole or an opposite side of the second preformed hole to thereby align a central axis of the tool to be centered between an axis of the first preformed hole and an axis of the second preformed hole, when the pilot member is inserted in the through-hole; and
advancing the tool under rotation into the through-hole to cause the countersink cutter to form a countersink centered between the axis of the first preformed hole and the axis of the second preformed hole.

18. The method of claim 17, wherein
at least a portion of a boundary of the first preformed hole and at least a portion of a boundary of the second preformed hole define a non-cylindrical perimeter of the through-hole, and
when the pilot member is inserted into the through-hole, the pilot member contacts the first side and the opposite side at respective locations where a major axis of the first preformed hole and the second preformed hole intersects the non-cylindrical perimeter.

19. The method of claim 17, the method further comprising:
prior to selecting a tool for creating the countersink hole:
selecting a temporary fastener having a shaft diameter equal to the preformed hole diameter minus the maximum allowable offset,
wherein determining that an actual offset distance is less than the maximum allowable offset distance includes determining that the temporary fastener can be inserted and pass through the through-hole; and
after advancing the tool to form the countersink:
selecting a final fastener having a final fastener shaft diameter that is equal to the pilot diameter;
inserting the final fastener into the through-hole and the countersink; and
fastening the final fastener.

20. The method of claim 17, wherein
the first preformed hole and the second preformed hole form a first preformed hole pair of multiple preformed hole pairs in a stack-up of the respective stacked components, each hole pair having a corresponding actual offset distance, and
determining that the actual offset distance is less than the maximum allowable offset distance includes determining for each of the hole pairs that the corresponding actual offset distance is less than or equal to the maximum allowable offset distance.

21. The method of claim 20, wherein
the stacked components are layers in the stack-up that are curved according to a curvature,
the actual offset distances of the multiple hole pairs vary, and
the actual offset distance of each hole pair is caused at least in part by a relative lateral shift in the layers at a location of the hole pair due to the curvature.
